(19) United States
(12) Patent Application Publication
(10) Pub. No.: US 2005/0157286 A1
(43) Pub. Date: Jul. 21, 2005

(54) Method and system for detecting sensitivity of photosensitive materials and exposure correcting method

(75) Inventor: Yoshiharu Sasaki, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/035,067

(22) Filed: Jan. 14, 2005

(30) Foreign Application Priority Data
Jan. 16, 2004 (JP) 009399/2004

(51) Int. Cl. G03B 27/72

(52) U.S. Cl. 355/71

(57) ABSTRACT

By use of an exposure apparatus provided with a spatial light modulation device, which has a plurality of pixel sections arrayed in two-dimensional directions, a plurality of images for sensitivity detection are formed on a photosensitive material, each of the images for sensitivity detection being constituted of a plurality of spot images dispersed within a predetermined unit area, the number of the spot images dispersed within the predetermined unit area being set so as to become large in stages among the plurality of the images for sensitivity detection. The sensitivity of the photosensitive material is detected in accordance with the plurality of the images for sensitivity detection, which have been formed on the photosensitive material.

### BACKGROUND OF THE INVENTION

1. Field of the Invention

This invention relates to a method and system for detecting sensitivity of a photosensitive material, in which an exposure apparatus provided with a spatial light modulation device having a plurality of pixel sections arrayed in two-dimensional directions is utilized. This invention also relates to an exposure correcting method.

2. Description of the Related Art

As wiring pattern forming techniques in fields of production of printed-wiring boards, techniques for performing photolithography by use of photosensitive materials have heretofore been proposed.

As one of the aforesaid techniques for performing photolithography by use of photosensitive materials, for example, a technique for directly irradiating light, which has been modulated by a spatial light modulation device, to a photosensitive material and thereby forming a wiring pattern has been proposed. (The technique for directly irradiating the light, which has been modulated by the spatial light modulation device, to the photosensitive material and thereby forming the wiring pattern is described in, for example, U.S. Pat. No. 6,251,550.)

As the spatial light modulation devices, transmission types of spatial light modulation devices and reflection types of spatial light modulation devices have heretofore been known. As one of the reflection types of spatial light modulation devices, a digital micromirror device (a trade name of Texas Instruments Co., hereinbelow referred to as the DMD) has been proposed. The DMD is a mirror device, in which a plurality of (e.g., 1,024×768) fine mirrors respectively constituting pixels are arrayed in a lattice-like pattern. Specifically, each of the fine mirrors is capable of being inclined and taking one of two angle positions in order to reflect light, which is irradiated to each of the fine mirrors, to one of two different directions in accordance with the angle position. Therefore, in cases where the photosensitive material is located at the position upon which the light having been reflected to one of the two different directions impinges, the light having been reflected to the other direction does not impinge upon the photosensitive material. Accordingly, the light irradiated to the photosensitive material is capable of being spatially modulated in units of one fine mirror. In cases where the angle positions of the fine mirrors are controlled in accordance with image information, an image corresponding to the image information is capable of being formed on the photosensitive material.

The sensitivity of the photosensitive material varies for different kinds of photosensitive materials. Also, even though the same kind of the photosensitive material is utilized, the sensitivity of the photosensitive material alters with the passage of time. Therefore, in cases where, for example, the wiring pattern is to be formed by use of the photosensitive material, before the formation of the wiring pattern, it is necessary to optimize energy of the light, which is to be irradiated to the photosensitive material, in accordance with the sensitivity of the photosensitive material. Further, in an irradiation apparatus for irradiating the light to the photosensitive material, energy of the irradiated light alters in accordance with the ambient temperature, the condition of the irradiation apparatus, and the like. Therefore, in cases where the same kind of the photosensitive material is utilized, before the formation of the wiring pattern, it is necessary to optimize energy of the light, which is to be irradiated to the photosensitive material. As techniques for optimizing energy of the irradiated light, for example, there have been proposed the techniques, wherein a mask for sensitivity detection is utilized. The mask for sensitivity detection is constituted of a base plate and a plurality of patterns, which are formed on the base plate. The plurality of the patterns constituting the mask for sensitivity detection are set such that the transmittances of the patterns with respect to the light irradiated to the photosensitive material become high in stages. With the techniques for optimizing energy of the irradiated light, wherein the mask for sensitivity detection is utilized, the light having passed through the mask for sensitivity detection is irradiated to the photosensitive material, and optimum energy of the irradiated light is detected in accordance with, for example, a thickness of the photosensitive material having been hardened with the light irradiation for each of the patterns constituting the mask for sensitivity detection. (The techniques for optimizing energy of the irradiated light, wherein the mask for sensitivity detection is utilized, are described in, for example, Japanese Unexamined Patent Publication No. 8(1996)-259663 and U.S. Patent Application Publication No. 20010006760.)

However, with the techniques for optimizing energy of the irradiated light, wherein the mask for sensitivity detection is utilized, the light transmittance of the base plate of the mask for sensitivity detection varies for different masks for sensitivity detection, and therefore a variation of the detected sensitivity occurs among the masks for sensitivity detection, which are used. Also, in cases where the mask for sensitivity detection, which is used, has clouds or stains, the sensitivity is not capable of being detected appropriately. Further, since the light transmittance of the mask for sensitivity detection alters with the passage of time, the detected sensitivity varies in accordance with the alteration of the light transmittance of the mask for sensitivity detection. Therefore, the variation of the detected sensitivity occurs as described above, and it is not always possible to adjust at optimum energy of the irradiated light.

### SUMMARY OF THE INVENTION

The primary object of the present invention is to provide a method of detecting sensitivity of a photosensitive material, wherein the sensitivity of the photosensitive material is capable of being detected accurately.

Another object of the present invention is to provide a system for carrying out the method of detecting sensitivity of a photosensitive material.

A further object of the present invention is to provide an exposure correcting method, wherein energy of light irradiated to a photosensitive material is capable of being corrected accurately in accordance with the sensitivity of the photosensitive material, which sensitivity has been detected with the method of detecting sensitivity of a photosensitive material.

The present invention provides a method of detecting sensitivity of a photosensitive material by use of an exposure apparatus provided with a spatial light modulation device, which has a plurality of pixel sections arrayed in two-dimensional directions and which radiates out an irradiated light beam from each of the pixel sections and in accordance with given image information, the exposure apparatus operating in order to form an image, which corresponds to the given image information and which is constituted of spot images in accordance with radiated light beams having been radiated out respectively from the pixel sections of the spatial light modulation device, on the photosensitive material,
the method comprising the steps of:
i) forming a plurality of images for sensitivity detection on the photosensitive material, each of the images for sensitivity detection being constituted of a plurality of the spot images dispersed within a predetermined unit area, the number of the spot images dispersed within the predetermined unit area being set so as to become large in stages among the plurality of the images for sensitivity detection, and
ii) detecting the sensitivity of the photosensitive material in accordance with the plurality of the images for sensitivity detection, which have been formed on the photosensitive material.

The method of detecting sensitivity of a photosensitive material in accordance with the present invention may be modified such that the photosensitive material is moved with respect to the spatial light modulation device, the plurality of the images for sensitivity detection being thereby formed on the photosensitive material, and
each of the spot images has a size larger than an array pitch of the spot images, which array pitch is taken in a direction normal to the direction of the movement of the photosensitive material with respect to the spatial light modulation device.

Also, the method of detecting sensitivity of a photosensitive material in accordance with the present invention may be modified such that each of the spot images has a size at least two times as large as the array pitch of the spot images, which array pitch is taken in the direction normal to the direction of the movement of the photosensitive material with respect to the spatial light modulation device.

Further, the method of detecting sensitivity of a photosensitive material in accordance with the present invention may be modified such that each of the spot images has a size larger than a width of a minimum element constituting the image information, which minimum element is represented by a predetermined recording resolution.

Furthermore, the method of detecting sensitivity of a photosensitive material in accordance with the present invention may be modified such that each of the spot images has a size at least two times as large as the width of the minimum element constituting the image information, which minimum element is represented by the predetermined recording resolution.

Also, the method of detecting sensitivity of a photosensitive material in accordance with the present invention may be modified such that each of the spot images has a size equal to at least a mean value of distances between centers of gravity on adjacent minimum elements constituting the image information, which minimum elements are represented by a predetermined recording resolution.

Further, the method of detecting sensitivity of a photosensitive material in accordance with the present invention may be modified such that a plurality of patterns for sensitivity detection, each of which is constituted of the plurality of the images for sensitivity detection, are formed on the photosensitive material, and
the sensitivity of the photosensitive material is detected with respect to each of the thus formed patterns for sensitivity detection.

As will be understood from the specification, it should be noted that the term “moving a photosensitive material with respect to a spatial light modulation device” as used herein means movement of the photosensitive material relative to the spatial light modulation device and embraces all of the cases wherein the photosensitive material is moved while the spatial light modulation device is kept stationary, cases wherein the spatial light modulation device is moved while the photosensitive material is kept stationary, and cases wherein both the photosensitive material and the spatial light modulation device are moved.

The present invention also provides an exposure correcting method, comprising the steps of:
i) obtaining information representing the sensitivity having been detected with the method of detecting sensitivity of a photosensitive material in accordance with the present invention, and
ii) correcting energy of the irradiated light beam, which is irradiated to each of the pixel sections of the spatial light modulation device at the time of an exposure operation performed by the exposure apparatus and with respect to a photosensitive material of the same kind as the photosensitive material having been subjected to the sensitivity detection, in accordance with the sensitivity having been detected with the method of detecting sensitivity of a photosensitive material in accordance with the present invention.

The term “same kind as a photosensitive material” as used herein means that the sensitivity of the photosensitive material is substantially identical with the sensitivity of the photosensitive material having been subjected to the sensitivity detection.

The present invention further provides a system for detecting sensitivity of a photosensitive material by use of an exposure apparatus provided with a spatial light modulation device, which has a plurality of pixel sections arrayed in two-dimensional directions and which radiates out an irradiated light beam from each of the pixel sections and in accordance with given image information, the exposure apparatus operating in order to form an image, which corresponds to the given image information and which is constituted of spot images in accordance with radiated light beams having been radiated out respectively from the pixel sections of the spatial light modulation device, on the photosensitive material,
the system comprising:
sensitivity detection control means for controlling the spatial light modulation device such that a plurality of images for sensitivity detection are formed on the photosensitive material, each of the images for sensitivity detection being constituted of a plurality of the spot images dispersed within a predetermined unit area, the number of the spot images dispersed within the predetermined unit area being set so as to become large in stages among the plurality of the images for sensitivity detection.

The system for detecting sensitivity of a photosensitive material in accordance with the present invention may be modified such that the system further comprises:
an optical system, which is located between the spatial light modulation device and the photosensitive material, the optical system forming the spot images in accordance with the radiated light beams, which have been radiated out respectively from the pixel sections of the spatial light modulation device, on the photosensitive material, and
movement means for moving the photosensitive material with respect to the optical system and the spatial light modulation device,
the optical system being constituted such that each of the spot images has a size larger than an array pitch of the spot images, which array pitch is taken in a direction normal to the direction of the movement of the photosensitive material with respect to the optical system and the spatial light modulation device.

Also, the system for detecting sensitivity of a photosensitive material in accordance with the present invention may be modified such that the optical system is constituted such that each of the spot images has a size at least two times as large as the array pitch of the spot images, which array pitch is taken in the direction normal to the direction of the movement of the photosensitive material with respect to the optical system and the spatial light modulation device.

Further, the system for detecting sensitivity of a photosensitive material in accordance with the present invention may be modified such that the system further comprises:
an optical system, which is located between the spatial light modulation device and the photosensitive material, the optical system forming the spot images in accordance with the radiated light beams, which have been radiated out respectively from the pixel sections of the spatial light modulation device, on the photosensitive material,
the optical system being constituted such that each of the spot images has a size larger than a width of a minimum element constituting the image information, which minimum element is represented by a predetermined recording resolution.

Furthermore, the system for detecting sensitivity of a photosensitive material in accordance with the present invention may be modified such that the optical system is constituted such that each of the spot images has a size at least two times as large as the width of the minimum element constituting the image information, which minimum element is represented by the predetermined recording resolution.

Also, the system for detecting sensitivity of a photosensitive material in accordance with the present invention may be modified such that the system further comprises:
an optical system, which is located between the spatial light modulation device and the photosensitive material, the optical system forming the spot images in accordance with the radiated light beams, which have been radiated out respectively from the pixel sections of the spatial light modulation device, on the photosensitive material,
the optical system being constituted such that each of the spot images has a size equal to at least a mean value of distances between centers of gravity on adjacent minimum elements constituting the image information, which minimum elements are represented by a predetermined recording resolution.

Further, the system for detecting sensitivity of a photosensitive material in accordance with the present invention may be modified such that the sensitivity detection control means controls the spatial light modulation device such that a plurality of patterns for sensitivity detection, each of which is constituted of the plurality of the images for sensitivity detection, are formed on the photosensitive material.

As will be understood from the specification, it should be noted that the term “moving a photosensitive material with respect to an optical system and a spatial light modulation device” as used herein means movement of the photosensitive material relative to the optical system and the spatial light modulation device and embraces all of the cases wherein the photosensitive material is moved while the optical system and the spatial light modulation device are kept stationary, cases wherein the optical system and the spatial light modulation device are moved while the photosensitive material is kept stationary, and cases wherein both the photosensitive material and the combination of the optical system and the spatial light modulation device are moved.

The spatial light modulation device employed in the method and system for detecting sensitivity of a photosensitive material in accordance with the present invention may be a transmission type of a spatial light modulation device. Alternatively, the spatial light modulation device may be a reflection type of a spatial light modulation device. For example, as the reflection type of the spatial light modulation device, a DMD may be employed. In cases where the DMD is employed as the spatial light modulation device, each of the pixel sections of the spatial light modulation device corresponds to one of the fine mirrors constituting the DMD.

By way of example, the size of each of the spot images may be the size of the region of the spot image, upon which region the light having an intensity equal to 1/e² of the maximum intensity of the light beam forming the spot image, impinges. Also, the term “size of a spot image” as used herein means the width of the spot image, which width is taken in the direction normal to the direction of the movement of the photosensitive material with respect to the spatial light modulation device or in the direction normal to the direction of the movement of the photosensitive material with respect to the optical system and the spatial light modulation device. By way of example, in cases where the spot image is a circular spot image, the size of the spot image is the diameter of the circular spot image. In cases where the spot image is a rectangular spot image, the size of the spot image is the length of the side extending in the direction normal to the direction of the movement described above.

Also, the term “array pitch of spot images” as used herein means the distance between the center points of the spot images, which are adjacent to each other in the direction normal to the direction of the movement described above.

The recording resolution is the information representing the size of the minimum element constituting the image information. By way of example, the recording resolution is represented in units of dpi.

The width of the minimum element is the length determined by the recording resolution. By way of example, in cases where the recording resolution of the image information is 12,700 dpi, the width of the minimum element is equal to the value calculated with the formula of 1 inch (=25,400 μm)/12,700 dots=2 μm, i.e. is equal to 2 μm.

With the method and system for detecting sensitivity of a photosensitive material in accordance with the present invention, the plurality of the images for sensitivity detection are formed on the photosensitive material. Each of the images for sensitivity detection is constituted of the plurality of the spot images dispersed within the predetermined unit area, and the number of the spot images dispersed within the predetermined unit area is set so as to become large in stages among the plurality of the images for sensitivity detection. Also, the sensitivity of the photosensitive material is detected in accordance with the plurality of the images for sensitivity detection, which have been formed on the photosensitive material. Therefore, the method and system for detecting sensitivity of a photosensitive material in accordance with the present invention have the advantages over the techniques, wherein the mask for sensitivity detection is utilized, in that there is no risk of the sensitivity detection being adversely affected by the mask for sensitivity detection, and the sensitivity of the photosensitive material is capable of being detected accurately.

The method and system for detecting sensitivity of a photosensitive material in accordance with the present invention may be modified such that the photosensitive material is moved with respect to the spatial light modulation device, the plurality of the images for sensitivity detection being thereby formed on the photosensitive material, and such that each of the spot images has the size larger than the array pitch of the spot images, which array pitch is taken in the direction normal to the direction of the movement of the photosensitive material with respect to the spatial light modulation device. In such cases, in each of the images for sensitivity detection, the spot images are capable of being formed such that parts of the spot images overlap each other, and the light beams are capable of being irradiated more uniformly to the photosensitive material. Also, the same effects are capable of being obtained in cases where each of the spot images has the size larger than the width of the minimum element constituting the image information, which minimum element is represented by the predetermined recording resolution, or in cases where each of the spot images has the size equal to at least the mean value of the distances between the centers of gravity on the adjacent minimum elements constituting the image information, which minimum elements are represented by the predetermined recording resolution.

The method and system for detecting sensitivity of a photosensitive material in accordance with the present invention may be modified such that the plurality of the patterns for sensitivity detection, each of which is constituted of the plurality of the images for sensitivity detection, are formed on the photosensitive material, and such that the sensitivity of the photosensitive material is detected with respect to each of the thus formed patterns for sensitivity detection. In such cases, a variation of the sensitivity of the photosensitive material over the surface of the photosensitive material is capable of being detected.

With the exposure correcting method in accordance with the present invention, the irradiated light quantity of the irradiated light beam, which is irradiated to each of the pixel sections of the spatial light modulation device at the time of the exposure operation performed by the exposure apparatus and with respect to the photosensitive material of the same kind as the photosensitive material having been subjected to the sensitivity detection, is corrected in accordance with the sensitivity having been detected with the method of detecting sensitivity of a photosensitive material in accordance with the present invention. Therefore, the light beam with the light quantity appropriate for the sensitivity of the photosensitive material is capable of being irradiated to the photosensitive material. Accordingly, the problems are capable of being prevented from occurring in that the photosensitive material is not hardened sufficiently due to an insufficient light quantity, and the wiring pattern is not formed appropriately, and in that the photosensitive material is hardened excessively due to an excessive light quantity, and the wiring pattern is not formed appropriately.

### BRIEF DESCRIPTION OF THE DRAWINGS

FIG. 1 is a perspective view showing an appearance of an exposure apparatus, which is employed in embodiments of the method and system for detecting sensitivity of a photosensitive material in accordance with the present invention,

FIG. 2 is a perspective view showing a scanner of the exposure apparatus of FIG. 1,

FIG. 3A is a plan view showing exposure-processed regions, which are formed on a photosensitive material,

FIG. 3B is an explanatory view showing an array of exposure processing areas, each of which is subjected to exposure processing performed by one of exposure heads,

FIG. 4 is a perspective view showing a constitution of an exposure head of the exposure apparatus of FIG. 1,

FIG. 5 is a partial enlarged view showing a digital micromirror device (DMD),

FIGS. 6A and 6B are explanatory views showing how the DMD operates,

FIG. 7 is an explanatory view showing a constitution and location of the DMD,

FIG. 8 is an explanatory view showing a pitch of micromirrors, which pitch is taken in a main scanning direction, in cases where the DMD is constituted as illustrated in FIG. 7,

FIG. 9 is an explanatory view showing an array of spot images formed in cases where the DMD is constituted as illustrated in FIG. 7,

FIG. 10 is an explanatory view showing a pitch of the spot images, which pitch is taken in the main scanning direction, in cases where the DMD is constituted as illustrated in FIG. 7,

FIG. 11 is a block diagram showing an electrical constitution of the exposure apparatus of FIG. 1,

FIG. 12 is an explanatory view showing image information, which is inputted into the exposure apparatus of FIG. 1,

FIG. 13 is an explanatory view showing relationship between a minimum element, which constitutes bit map data formed by the exposure apparatus of FIG. 1, and the spot images,

FIG. 14 is an explanatory view showing an example of a pattern for sensitivity detection, which is constituted of a plurality of images for sensitivity detection formed with the method and system for detecting sensitivity of a photosensitive material in accordance with the present invention,

FIG. 15 is an explanatory view showing an example of how sensitivity detection is performed in an embodiment of the method of detecting sensitivity of a photosensitive material in accordance with the present invention,

FIG. 16 is an explanatory view showing an example of how exposure correction is performed in an embodiment of the exposure correcting method in accordance with the present invention,

FIG. 17 is an explanatory view showing examples of images for resolution detection, and

FIG. 18 is an explanatory view showing examples of images for adhesion properties detection.

### DESCRIPTION OF THE PREFERRED EMBODIMENTS

The present invention will hereinbelow be described in further detail with reference to the accompanying drawings.

Embodiments of the method and system for detecting sensitivity of a photosensitive material in accordance with the present invention will be described hereinbelow. In the embodiments of the method and system for detecting sensitivity of a photosensitive material in accordance with the present invention, an exposure apparatus is utilized. The exposure apparatus is provided with a spatial light modulation device, which has a plurality of pixel sections arrayed in two-dimensional directions and which radiates out an irradiated light beam from each of the pixel sections and in accordance with given image information. Firstly, the exposure apparatus will be described hereinbelow.

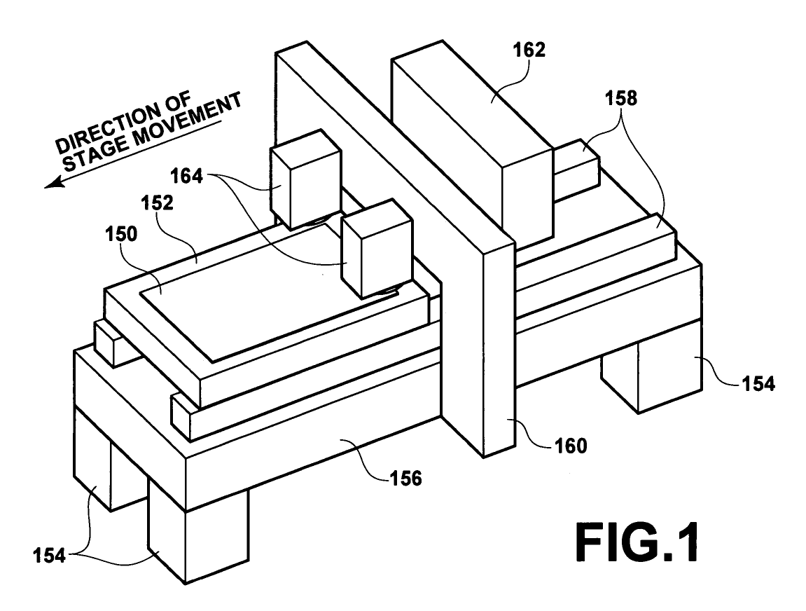

As illustrated in FIG. 1, the exposure apparatus is provided with a flat plate-like moving stage 152 for supporting a sheet-shaped photosensitive material 150 on the surface by suction. The exposure apparatus is also provided with a thick plate-shaped support base 156, which is supported by four pillars 154, 154, . . . The exposure apparatus is further provided with two guides 158, 158 secured to the top surface of the support base 156. The guides 158, 158 extend along a direction of movement of the stage 152. The stage 152 is located such that its longitudinal direction extends in the direction of movement of the stage 152. The stage 152 is supported by the guides 158, 158 such that the stage 152 is capable of moving reciprocally.

A U-shaped gate 160 is located at a middle part of the support base 156. The U-shaped gate 160 extends over the movement path of the stage 152. Ends of the U-shaped gate 160 are secured respectively to opposite side faces of the support base 156. The U-shaped gate 160 supports a scanner 162 on one side of the U-shaped gate 160, which side is taken with respect to the direction of movement of the stage 152. The U-shaped gate 160 is provided with a plurality of (e.g., two) sensors 164, 164 on the other side of the U-shaped gate 160, which side is taken with respect to the direction of movement of the stage 152. The sensors 164, 164 detect a leading end and a tail end of the photosensitive material 150. The scanner 162 and the sensors 164, 164 are thus secured to the opposite sides of the U-shaped gate 160 and are located above the movement path of the stage 152. The scanner 162 and the sensors 164, 164 are connected to a controller (not shown) for controlling the scanner 162 and the sensors 164, 164.

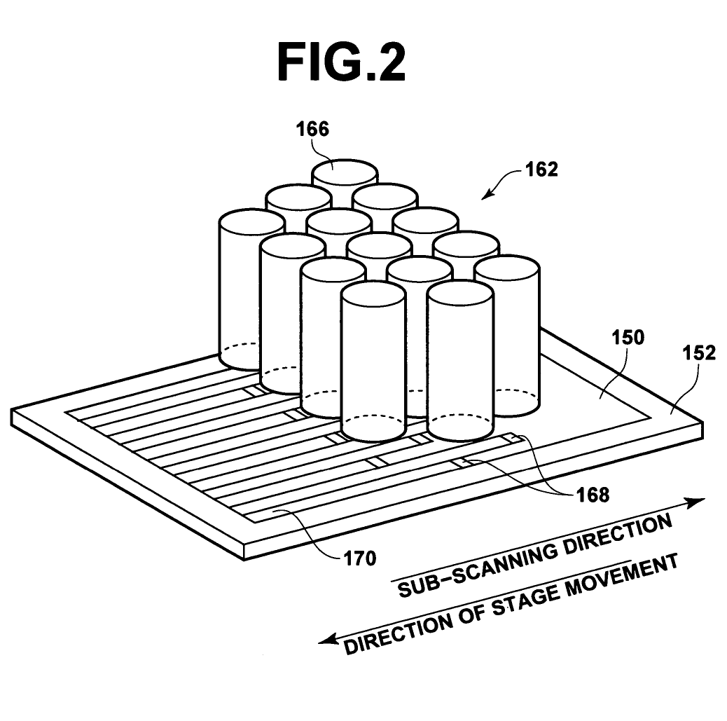

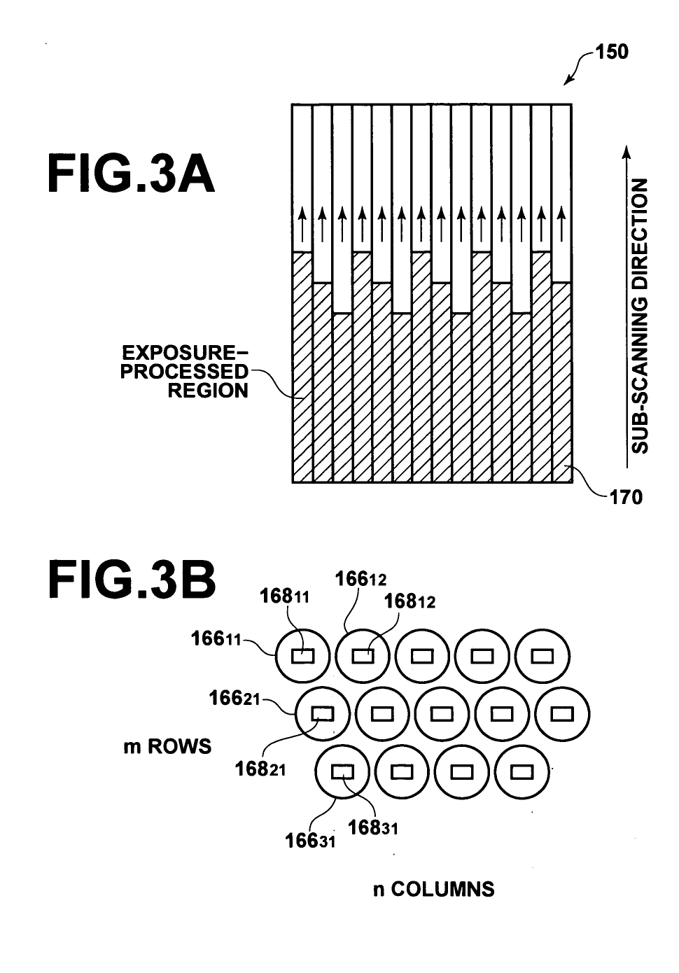

As illustrated in FIG. 2 and FIG. 3B, the scanner 162 is provided with a plurality of (e.g., 14) exposure heads 166, 166, . . . , which are arrayed approximately in a matrix-like pattern composed of “m” number of rows and “n” number of columns (e.g., three rows and five columns). In this embodiment, in accordance with the width of the photosensitive material 150, four exposure heads 166, 166, . . . are located along the third row. In cases where a certain exposure head 166 in the array of the exposure heads 166, 166, . . . , which certain exposure head is located at a position of an m'th row and an n'th column in the array of the exposure heads 166, 166, . . . , is to be represented, the certain exposure head 166 is herein represented as an exposure head 166ₘₙ.

As illustrated in FIG. 3B, an exposure processing area 168 corresponding to each exposure head 166, which exposure processing area is subjected to the exposure processing performed by the exposure head 166, has a rectangular shape, whose short side extends along a sub-scanning direction. Therefore, as illustrated in FIG. 2 and FIG. 3A, as the stage 152 moves, a band-shaped exposure-processed region 170 corresponding to each exposure head 166 is formed on the photosensitive material 150. In cases where a certain exposure processing area 168 corresponding to an exposure head 166, which is located at a position of an m'th row and an n'th column in the array of the exposure heads 166, 166, . . . , is to be represented, the certain exposure processing area 168 is herein represented as an exposure processing area 168ₘₙ.

As illustrated in FIGS. 3A and 3B, in the array of the exposure heads 166, 166, . . . of the scanner 162, a row of the exposure heads 166, 166, . . . arrayed in a line and an adjacent row of the exposure heads 166, 166, . . . arrayed in a line are shifted by a predetermined distance (which is positive integer times as large as the length of the major side of each of the exposure processing areas 168, 168, . . . , and which is two times as large as the length of the major side of each of the exposure processing areas 168, 168, . . . in this embodiment) from each other with respect to the array direction. The exposure heads 166, 166, . . . are thus located such that the band-shaped exposure-processed regions 170, 170, . . . may be formed on the photosensitive material 150 without any unprocessed space being left between the band-shaped exposure-processed regions 170, 170, . . . in the direction normal to the sub-scanning direction. Therefore, the areas, which are located between, for example, an exposure processing area 168₁₁, and an exposure processing area 168₁₂ corresponding respectively to an exposure head 166₁₁ and an exposure head 166₁₂ located along the first row, and which are not capable of being subjected to the exposure processing performed by the exposure head 166₁₁ and the exposure head 166₁₂, are capable of being exposure-processed with an exposure head 166₂₁, which is located along the second row and corresponds to an exposure processing area 168₂₁, and an exposure head 166₃₁, which is located along the third row and corresponds to an exposure processing area 168₃₁.

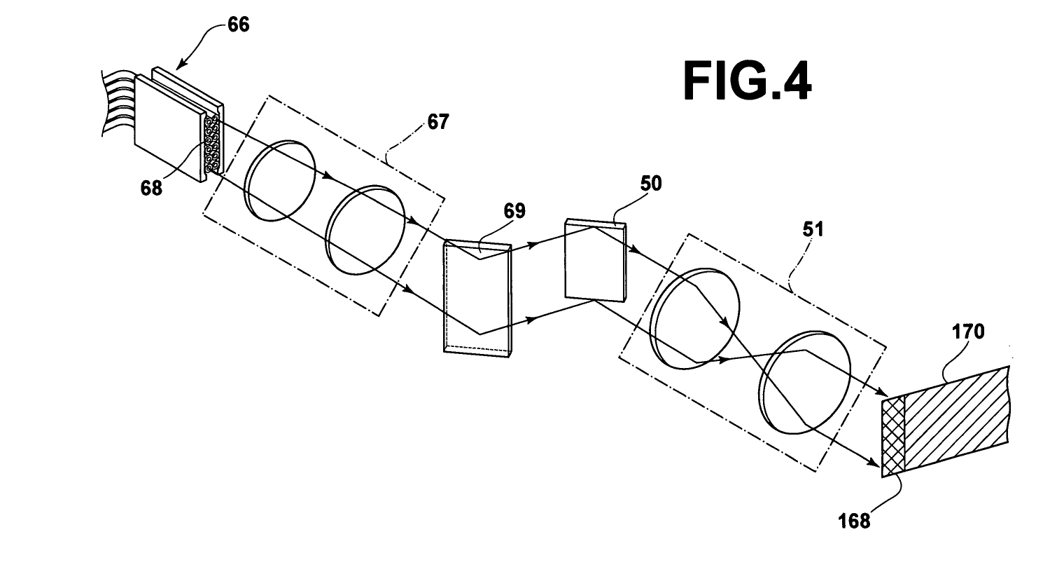

As illustrated in FIG. 4, each of the exposure heads 166₁₁ to 166ₘₙ is provided with a digital micromirror device (DMD) 50 acting as the spatial light modulation means for modulating an incident light beam in accordance with the image information.

As illustrated in FIG. 5, the DMD 50 comprises SRAM cells (memory cells) 60 and micromirrors 62, 62, . . . , which act as the fine mirrors and are supported on the SRAM cells 60 by support rods. The micromirrors 62, 62, . . . , each of which constitutes one of the pixel sections, are arrayed in a lattice-like pattern. A material having a high reflectivity, such as aluminum, has been deposited with a vacuum evaporation technique on the surfaces of the micromirrors 62, 62, . . . The reflectivity of each of the micromirrors 62, 62, . . . is equal to at least 90%. Also, each of silicon gate CMOS SRAM cells 60 produced with an ordinary semiconductor memory producing line is located exactly under one of the micromirrors 62, 62, . . . via the support rod provided with a hinge and a yoke. The DMD 50 has a monolithic structure as a whole.

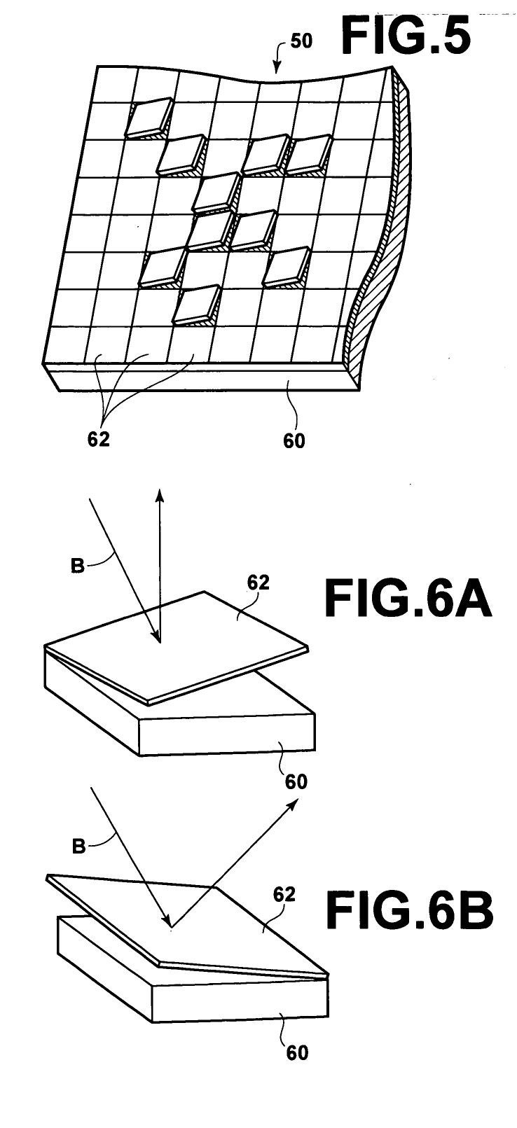

A signal component of a digital signal representing the image information is written in one of the SRAM cells 60 of the DMD 50. In such cases, in accordance with the signal component of the digital signal, the micromirror 62, which corresponds to the SRAM cell 60 and is supported by the support rod, is inclined around a diagonal line of the micromirror 62 and at an angle falling within the range of ±α degrees (e.g., ±10 degrees) with respect to a base plate, on which the DMD 50 is located. FIG. 6A shows an “on” state of the micromirror 62, in which the micromirror 62 has been inclined at an angle of +α degrees. FIG. 6B shows an “off” state of the micromirror 62, in which the micromirror 62 has been inclined at an angle of −α degrees. The photosensitive material 150 is located at a position, to which a laser beam B having been reflected from the micromirror 62 in the “on” state travels. Also, a light absorber (not shown) is located at a position, to which the laser beam B having been reflected from the micromirror 62 in the “off” state travels. In this manner, an image corresponding to the image information is capable of being formed on the photosensitive material 150.

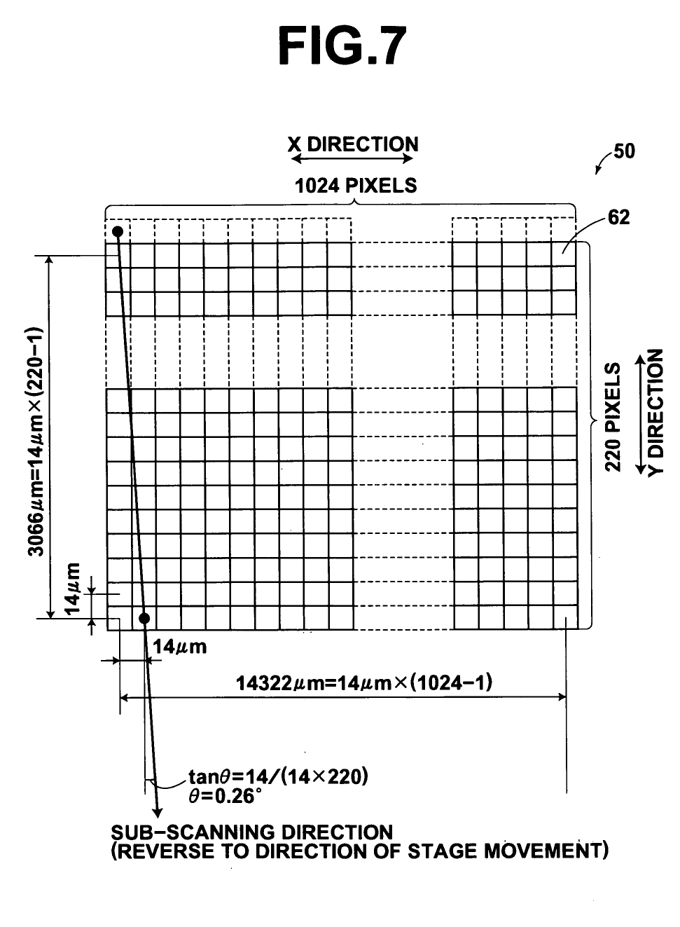

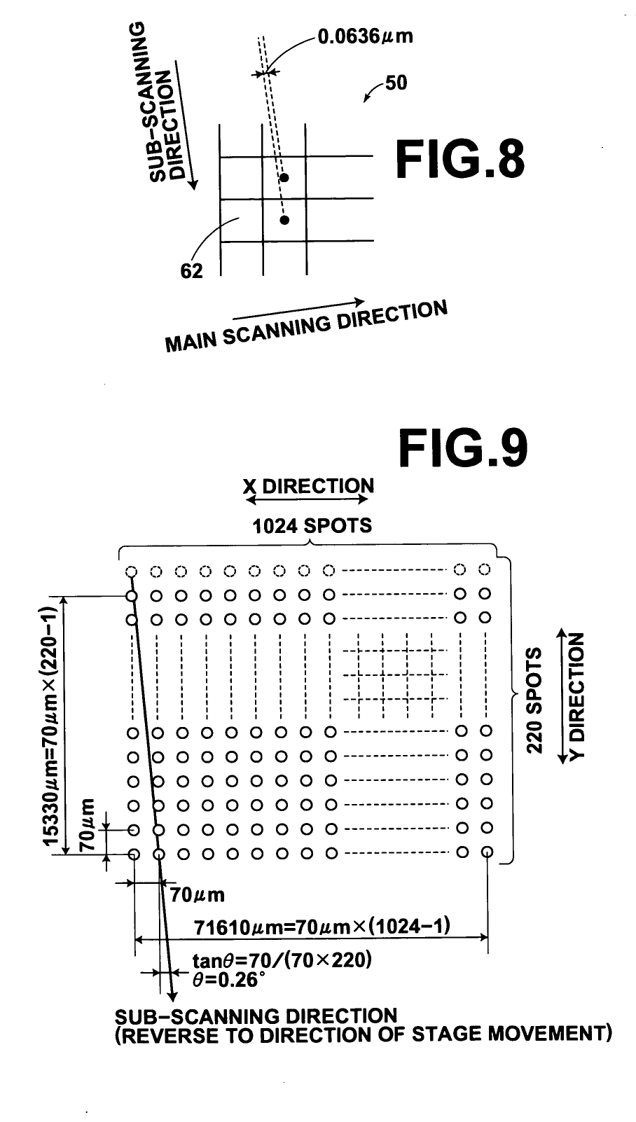

The DMD 50 comprises an array of the micromirrors 62, 62, . . . , which array is composed of a plurality of columns of the micromirrors 62, 62, . . . standing side by side with respect to the longitudinal direction of the DMD 50 and a plurality of rows of the micromirrors 62, 62, . . . standing side by side with respect to the lateral direction of the DMD 50. The DMD 50 should preferably be located in a slightly inclined orientation such that the minor side of the DMD 50 may makes a predetermined angle θ (e.g., an angle falling within the range of 0.1° to 1°) with respect to the sub-scanning direction. Specifically, for example, as illustrated in FIG. 7, 1,024-pixel micromirrors 62, 62, . . . may be arrayed at pitches of 14 μm in an X direction, and 220-pixel micromirrors 62, 62, . . . may be arrayed at pitches of 14 μm in a Y direction, which is normal to the X direction. In this manner, the DMD 50 having a size of 3,066 μm×14,322 μm may be constituted. The thus constituted DMD 50 may be located in an orientation such that the sub-scanning direction (which is reverse to the direction of movement of the stage 152) may be inclined at the angle θ with respect to the Y direction. In FIG. 7, a pixel array indicated by the broken lines are the pixel array, which is not located actually and is illustrated merely for the explanation of how the angle θ is calculated. The angle θ is calculated with the formula of tan θ=14 μm/(14 μm×220 pixels). In cases where the DMD 50 is located in the inclined orientation as described above, the pitch of the spot images, each of which is formed with the laser beam having been radiated out from one of the micromirrors 62, 62, . . . , is capable of being set to be smaller than the pitch of the spot images, which are formed incases where the DMD 50 is located in an un-inclined orientation. As a result, the resolution is capable of being enhanced markedly. In cases where the DMD 50 is constituted in the manner described above, as illustrated in FIG. 8, the pitch of the micromirrors 62, 62, . . . , which pitch is taken in a main scanning direction normal to the sub-scanning direction, becomes equal to 0.0636 μm.

Reverting to FIG. 4, a fiber array light source 66, a lens system 67, and a mirror 69 are located in this order on the light incidence side of the DMD 50. The fiber array light source 66 is provided with a laser beam radiating section 68, in which radiating ends (light emitting points) of optical fibers are arrayed in a line along a direction corresponding to the direction of the major side of the corresponding exposure processing area 168 on the photosensitive material 150. The lens system 67 corrects the laser beams having been radiated out from the fiber array light source 66 and causes the laser beams to travel toward the DMD 50. The mirror 69 reflect the laser beams, which have passed through the lens system 67, toward the DMD 50. The lens system 67 described above collects the laser beams having been radiated out from the fiber array light source 66 and causes the laser beams to impinge upon the DMD 50 as light beams, each of which takes on the form of an approximately collimated light beam and has uniform intensity in a beam cross-section.

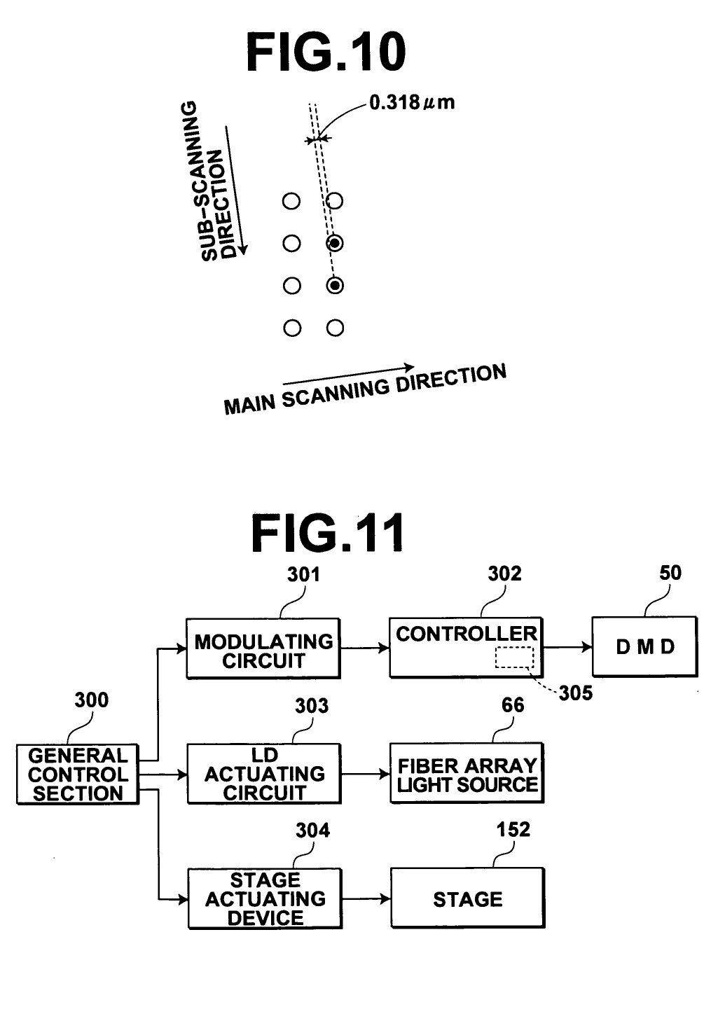

Also, an image forming optical system 51 for forming an image of each of the laser beams, which have been reflected from the DMD 50, on the photosensitive material 150 is located on the light radiating side of the DMD 50. The image forming optical system 51 forms the image of each of the laser beams, which have been reflected from the pixel sections of the DMD 50, as the spot image on the photosensitive material 150. Specifically, for example, as illustrated in FIG. 9, the image forming optical system 51 may be constituted such that each of the pitch of the spot images with respect to the X direction and the pitch of the spot images with respect to the Y direction may become equal to 70 μm, which is five times as large as each of the pixel pitch with respect to the X direction illustrated in FIG. 7 and the pixel pitch with respect to the Y direction illustrated in FIG. 7. In cases where the image forming optical system 51 is constituted in the manner described above, the size of the area, over which the spot images are formed by the DMD 50, becomes equal to 15,330 μm×71,610 μm. Also, the size of each of the spot images is adjusted by a microlens array, which is contained in the image forming optical system 51. The size of each of the spot images is determined by the optical magnification of the image forming optical system 51 and is also adjusted by apertures, which are contained in the image forming optical system 51. The size of each of the spot images should preferably be set at 10 μm. Further, in cases where the image forming optical system 51 is constituted in the manner described above, as illustrated in FIG. 10, the array pitch of the spot images with respect to the main scanning direction normal to the sub-scanning direction becomes equal to 0.318 μm. The size of each of the spot images is not limited to 10 μm. The size of each of the spot images may be equal to at least the array pitch of the spot images with respect to the main scanning direction, and should preferably be at least two times as large as the array pitch of the spot images with respect to the main scanning direction.

The exposure apparatus described above is also provided with a general control section 300. As illustrated in FIG. 11, the general control section 300 is connected to a modulating circuit 301, and a controller 302 for controlling the DMD 50 is connected to the modulating circuit 301. In the controller 302, a control signal for controlling the actuation of each of the micromirrors 62, 62, . . . of the DMD 50 is formed in accordance with the image information. The angle of the reflecting surface of each of the micromirrors 62, 62, . . . of the DMD 50 is controlled in accordance with the control signal. The general control section 300 is also connected to an LD actuating circuit 303 for actuating the fiber array light source 66. The general control section 300 is further connected to a stage actuating device 304 for actuating the stage 152.

How the exposure apparatus described above operates will be described hereinbelow. Firstly, the fiber array light source 66 is actuated by the LD actuating circuit 303 illustrated in FIG. 11, and the laser beams are radiated out from the laser beam radiating section 68 of the fiber array light source 66 in each of the exposure heads 166, 166, . . . of the scanner 162. The laser beams having been radiated out from the fiber array light source 66 impinge upon the lens system 67. The laser beams are corrected by the lens system 67 and impinge upon the mirror 69. The laser beams are reflected from the mirror 69 and irradiated to the DMD 50. The laser beams having been reflected from the DMD 50 impinge upon the image forming optical system 51, and the images of the laser beams are formed on the photosensitive material 150 by the image forming optical system 51.

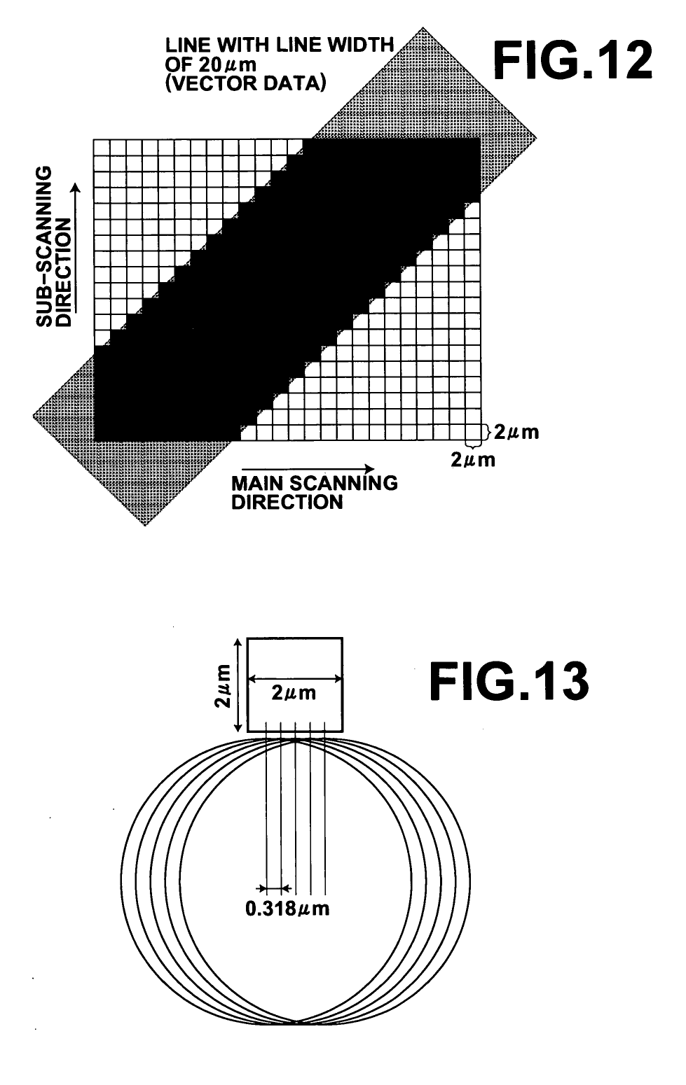

The laser beams impinge upon the DMD 50 in the manner described above, and the digital signal representing the image information is fed from the modulating circuit 301 illustrated in FIG. 11 into the controller 302 for the DMD 50. The digital signal is stored in a frame memory of the controller 302. The image information is data representing the image density of each of the pixels, which constitute the image, by the binary notation (representing whether a dot is to be or is not to be recorded). The image information, which is inputted into the exposure apparatus, is the vector data, such as the CAD data or the CAM data. By way of example, in cases where the image is a straight line image, the vector data includes the information representing a starting point having coordinates (X, Y), the information representing an end point having coordinates (X, Y), and the information representing the thickness of the line. The exposure apparatus converts the vector data described above into bit map data by use of a raster image processor (RIP, not shown). For example, in cases where the vector data, which represents an oblique line having a width of 20 μm, is converted into the bit map data with a recoding resolution of 12,700 dpi, the vector data is converted into the 2 μm-pitch bit map data with the formula of 1 inch (=25,400 μm)/12,700 dots=2 μm. Also, in such cases, the micromirrors 62, 62, . . . of the DMD 50 are on-off controlled such that the spot images may be formed in the black region illustrated in FIG. 12. As illustrated in FIG. 13, in cases where the DMD 50 and the image forming optical system 51 are constituted such that the spot images may be formed as illustrated in FIG. 10, the center points of five spot images are located within the 2 μm-square area of the minimum element constituting the bit map data. The size of each of the spot images should preferably be larger than the width (2 μm) of the minimum element constituting the bit map data described above. The size of each of the spot images should more preferably be at least two times as large as the width of the minimum element constituting the bit map data described above. Alternatively, the size of each of the spot images may be equal to at least a mean value of distances between centers of gravity on adjacent minimum elements constituting the bit map data described above.

The stage 152 having the surface, on which the photosensitive material 150 has been supported by suction, is moved by the stage actuating device 304, which is illustrated in FIG. 11, at a predetermined speed from the side more upstream than the U-shaped gate 160 to the side more downstream than the U-shaped gate 160 along the guides 158, 158 and under the U-shaped gate 160. At the time at which the stage 152 passes under the U-shaped gate 160, the leading end of the photosensitive material 150 is detected by the sensors 164, 164, which are secured to the U-shaped gate 160. After the leading end of the photosensitive material 150 has been detected by the sensors 164, 164, the image signal components of the image signal, which has been stored in the frame memory of the controller 302, are successively read from the frame memory in units of a plurality of scanning lines. In accordance with the thus read image signal components of the image signal, the control signal for each of the exposure heads 166, 166, . . . is formed. In accordance with the control signal having been formed in the manner described above, each of the micromirrors 62, 62, . . . of the DMD 50 of each of the exposure heads 166, 166, . . . is on-off controlled.

Each of the laser beams, which have been radiated out from the fiber array light source 66, is on-off controlled for each of the pixel sections of the DMD 50, and the photosensitive material 150 is exposed to the laser beams in units of the number of pixels, which number is approximately identical with the number of the used pixels of the DMD 50. Also, the photosensitive material 150 is moved at the predetermined speed together with the stage 152. Therefore, the photosensitive material 150 is scanned with the scanner 162 in the sub-scanning direction, which is reverse to the direction of movement of the stage 152, and each of the band-shaped exposure-processed regions 170, 170, . . . is formed by one of the exposure heads 166, 166, . . . As described above, the exposure processing area 168, which is subjected to the exposure processing with one exposure head 166, has the rectangular shape. However, the plurality of the spot images, which are located within the exposure processing area 168, are the fine circular images.

When the scanning of the photosensitive material 150 with the scanner 162 in the sub-scanning direction has been finished, and the tail end of the photosensitive material 150 has been detected by the sensors 164, 164, the stage 152 is returned by the stage actuating device 304 along the guides 158, 158 to the original position, which is located on the side most upstream than the U-shaped gate 160. The stage 152 is again moved at the predetermined speed from the side more upstream than the U-shaped gate 160 to the side more downstream than the U-shaped gate 160 along the guides 158, 158.

The method and system for detecting sensitivity of a photosensitive material in accordance with the present invention, wherein the exposure apparatus described above is employed, will be described hereinbelow.

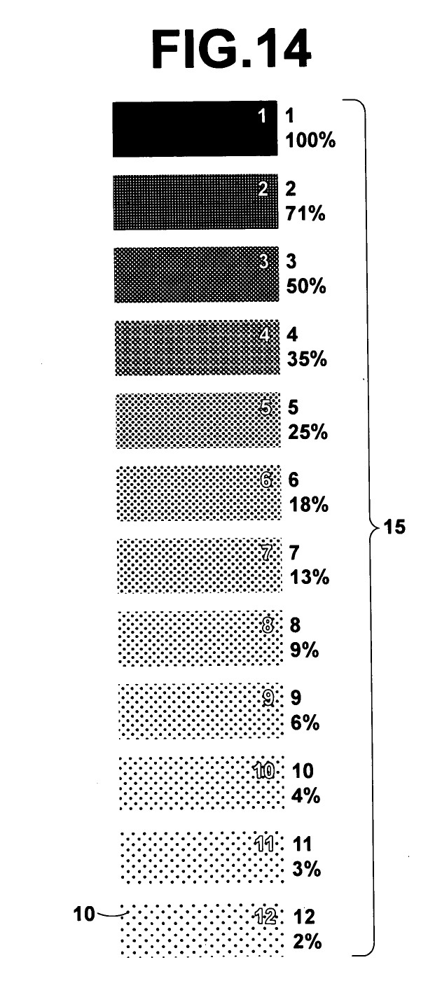

In the method and system for detecting sensitivity of a photosensitive material in accordance with the present invention, as illustrated in FIG. 14, a plurality of images 10, 10, . . . for sensitivity detection are formed on the photosensitive material 150. Specifically, as illustrated in FIG. 11, the controller 302 of the exposure apparatus is provided with sensitivity detection control means 305. The DMD 50 is controlled in accordance with a control signal given by the sensitivity detection control means 305, such that the plurality of the images 10, 10, . . . for sensitivity detection as illustrated in FIG. 14 may be formed on the photosensitive material 150. Each of the images 10, 10, . . . for sensitivity detection is constituted of a plurality of the spot images dispersed within a predetermined unit area, the number of the spot images dispersed within the predetermined unit area being set so as to become large in stages among the plurality of the images 10, 10, . . . for sensitivity detection.

In FIG. 14, the percentage indicated on the right-hand side of each of the images 10, 10, . . . for sensitivity detection represents the ratio of the number of the spot image, which have been formed within the unit area on the photosensitive material 150, to the number of the spot images, which are capable of being located within the unit area. Specifically, the percentage indicated on the right-hand side of each of the images 10, 10, . . . for sensitivity detection in FIG. 14 represents energy of the laser beams, which are irradiated to the unit area of the photosensitive material 150. Also, each of the numerals of 1 to 12 illustrated in FIG. 14 represents the stage of energy described above. Specifically, an image 10 for sensitivity detection, which is associated with a stage represented by a small numeral, is an image, which has been formed with large energy.

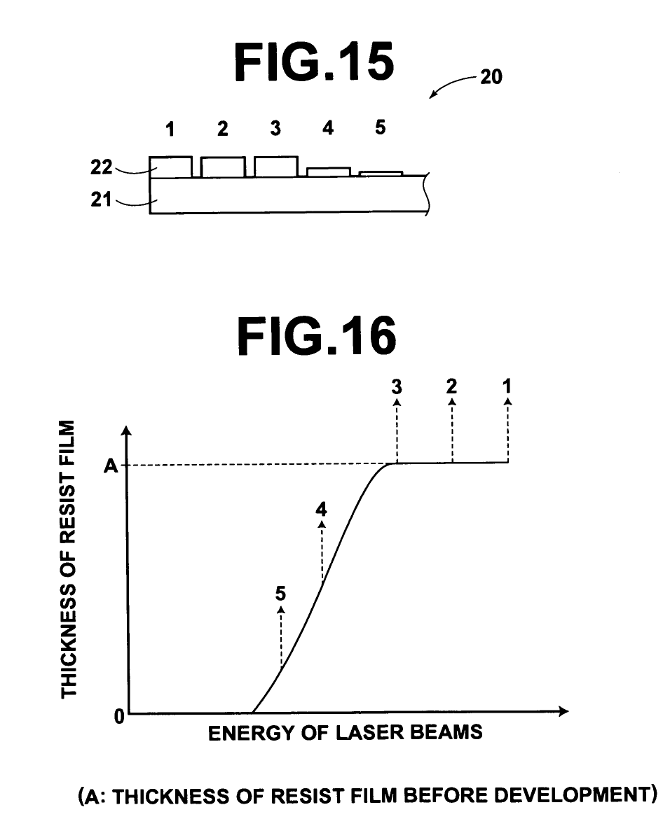

By way of example, in cases where the photosensitive material 150 is aboard for printed wiring, which board comprises a copper plate and a resist film formed on the surface of the copper plate, the exposure operation is performed on the board for printed wiring, and the plurality of the images 10, 10, . . . for sensitivity detection are formed on the board for printed wiring and developed. After the development, the film thicknesses of the resist film remaining on the copper plate are measured. In this manner, the sensitivity of the photosensitive material 150 is capable of being detected. Specifically, as illustrated in FIG. 15, aboard 20 for printed wiring is obtained after the development has been performed. The board 20 for printed wiring is obtained such that a resist film 22 having thicknesses corresponding to the stages described above remains on a copper plate 21. Therefore, for example, in cases where the resist film 22 remains on the copper plate 21 as illustrated in FIG. 15, the resist film and energy of the laser beams have the relationship as illustrated in FIG. 16. Accordingly, in such cases, the sensitivity of the board 20 for printed wiring is capable of being detected as being the stage 3.

Further, in case where the sensitivity of the board 20 for printed wiring has been detected as being the stage 3 in the manner described above, energy of the laser beams to be irradiated to the board 20 for printed wiring, which board acts as the photosensitive material, is capable of being corrected in accordance with the detected sensitivity. Specifically, from the view point of the resolution and the adhesion properties of the resist film, it is sufficient for energy of the laser beams to be the stage 2. Therefore, energy of the laser beams to be irradiated to the board 20 for printed wiring may be corrected so as to become 71% of energy of the laser beams having been used for the sensitivity detection described above. In order for energy correction to be performed, for example, the LD actuating circuit 303 may be controlled, and the light quantity of the laser beams, which are radiated out from the fiber array light source 66, per unit time may thereby be controlled. Alternatively, the stage actuating device 304 may be controlled, and the movement speed of the stage 152 may thereby be controlled.

Also, the DMD 50 may be controlled by the sensitivity detection control means 305, such that a plurality of patterns 15, 15, . . . for sensitivity detection, each of which is constituted of the plurality of the images 10, 10, . . . for sensitivity detection as illustrated in FIG. 14, may be formed on the photosensitive material 150. For example, in cases where the patterns 15, 15, . . . for sensitivity detection are formed at a plurality of positions over the entire area of the photosensitive material 150, a variation of the sensitivity of the photosensitive material 150 over the surface of the photosensitive material 150 is capable of being detected. Further, for example, in cases where the detected variation of the sensitivity of the photosensitive material 150 over the surface of the photosensitive material 150 is large, energy of the laser beams to be irradiated to the photosensitive material may be corrected in accordance with the lowest sensitivity.

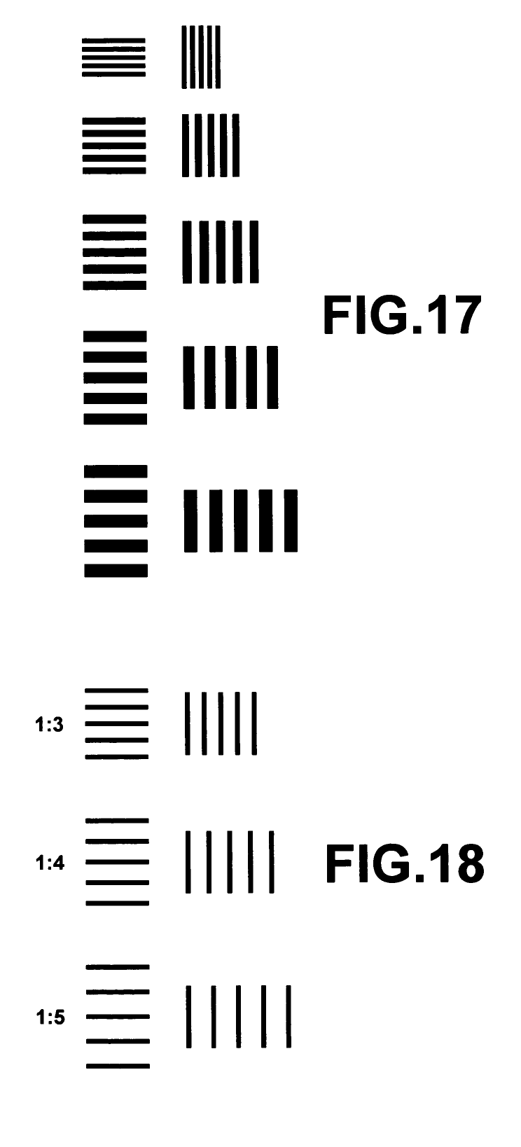

Besides the formation of the images 10, 10, . . . for sensitivity detection on the photosensitive material 150, images for resolution detection or images for adhesion properties detection may be formed on the photosensitive material. The images for resolution detection are the images utilized for confirming the resolution of the photosensitive material. For example, as illustrated in FIG. 17, the images for resolution detection are constituted of a plurality of images, in each of which a plurality of horizontal lines are arrayed, and a plurality of images, in each of which a plurality of vertical lines are arrayed. The plurality of the images, in each of which the plurality of the horizontal lines are arrayed, are formed such that the line width and the line spacing become large in stages. Also, the plurality of the images, in each of which the plurality of the vertical lines are arrayed, are formed such that the line width and the line spacing become large in stages. In the image of each stage, the ratio of the line width to the line spacing is equal to 1:1. Also, for example, the line width and the line spacing may become large from 10 μm:10 μm in stages by several microns per stage.

In cases where the photosensitive material is the board for printed wiring as described above, the images for adhesion properties detection are the images utilized for confirming the adhesion properties of the resist film 22 with respect to the copper plate 21. For example, as illustrated in FIG. 18, the images for adhesion properties detection are constituted of a plurality of images, in each of which a plurality of horizontal lines are arrayed, and a plurality of images, in each of which a plurality of vertical lines are arrayed. The plurality of the images, in each of which the plurality of the horizontal lines are arrayed, are formed such that the ratio of the line spacing to the line width become large in stages. Also, the plurality of the images, in each of which the plurality of the vertical lines are arrayed, are formed such that the ratio of the line spacing to the line width become large in stages. The ratio illustrated in FIG. 18 is the ratio of the line width to the line spacing in each of the images, which are illustrated on the right-hand side. By way of example, the line width and the line spacing may be set such that the ratio of the line width to the line spacing may be 10 μm:30 μm, 10 μm:40 μm, and 10 μm:50 μm.

In the embodiments described above, each of the exposure heads 166, 166, . . . is provided with the DMD 50 as the spatial light modulation device. Alternatively, an exposure apparatus comprising exposure heads, each of which is provided with a micro electro mechanical systems (MEMS) type of a spatial light modulator (SLM), may be employed. As another alternative, an exposure apparatus comprising exposure heads, each of which is provided with a spatial light modulator, such as an optical device (PLZT device) for modulating passing light with an electro-optic effect or a liquid crystal light shutter (FCL), other than the MEMS type of the spatial light modulator, may be employed. The MEMS represent a group of fine systems, in which a micro-size sensor, an actuator, and a control circuit are integrated with a micro-machining technique based upon IC producing processes. The MEMS type of the spatial light modulator is the spatial light modulator actuated by electromechanical operations utilizing electrostatic force.

As the resist film of the photosensitive material 150 in the embodiments described above, a dry film resist (DFR) may be utilized. Also, besides the utilization for the process for producing the printed-wiring board as in the embodiments described above, the method and system for detecting sensitivity of a photosensitive material in accordance with the present invention and the exposure correcting method in accordance with the present invention may be utilized at the time of the detection of the sensitivity of the photosensitive material in production processes using other kinds of photosensitive materials. For example, the method and system for detecting sensitivity of a photosensitive material in accordance with the present invention and the exposure correcting method in accordance with the present invention may be utilized at the time of the formation of color filters in processes for producing liquid crystal display devices (LCD), at the time of the exposure operation for DFR in TFT producing processes, and at the time of the exposure operation for DFR in processes for producing plasma display panels (PDP).

Further, the photosensitive material may be of any constitution. For example, the method and system for detecting sensitivity of a photosensitive material in accordance with the present invention and the exposure correcting method in accordance with the present invention may be utilized for a photosensitive material, in which the photosensitive layer is constituted of a single layer, or for a photosensitive material, which is provided with a plurality of photosensitive layers having different sensitivities.

1. A method of detecting sensitivity of a photosensitive material by use of an exposure apparatus provided with a spatial light modulation device, which has a plurality of pixel sections arrayed in two-dimensional directions and which radiates out an irradiated light beam from each of the pixel sections and in accordance with given image information, the exposure apparatus operating in order to form an image, which corresponds to the given image information and which is constituted of spot images in accordance with radiated light beams having been radiated out respectively from the pixel sections of the spatial light modulation device, on the photosensitive material,
the method comprising the steps of:
i) forming a plurality of images for sensitivity detection on the photosensitive material, each of the images for sensitivity detection being constituted of a plurality of the spot images dispersed within a predetermined unit area, the number of the spot images dispersed within the predetermined unit area being set so as to become large in stages among the plurality of the images for sensitivity detection, and
ii) detecting the sensitivity of the photosensitive material in accordance with the plurality of the images for sensitivity detection, which have been formed on the photosensitive material.

2. A method of detecting sensitivity of a photosensitive material as defined in claim 1 wherein the photosensitive material is moved with respect to the spatial light modulation device, the plurality of the images for sensitivity detection being thereby formed on the photosensitive material, and
each of the spot images has a size larger than an array pitch of the spot images, which array pitch is taken in a direction normal to the direction of the movement of the photosensitive material with respect to the spatial light modulation device.

3. A method of detecting sensitivity of a photosensitive material as defined in claim 2 wherein each of the spot images has a size at least two times as large as the array pitch of the spot images, which array pitch is taken in the direction normal to the direction of the movement of the photosensitive material with respect to the spatial light modulation device.

4. A method of detecting sensitivity of a photosensitive material as defined in claim 1 wherein each of the spot images has a size larger than a width of a minimum element constituting the image information, which minimum element is represented by a predetermined recording resolution.

5. A method of detecting sensitivity of a photosensitive material as defined in claim 4 wherein each of the spot images has a size at least two times as large as the width of the minimum element constituting the image information, which minimum element is represented by the predetermined recording resolution.

6. A method of detecting sensitivity of a photosensitive material as defined in claim 1 wherein each of the spot images has a size equal to at least a mean value of distances between centers of gravity on adjacent minimum elements constituting the image information, which minimum elements are represented by a predetermined recording resolution.

7. A method of detecting sensitivity of a photosensitive material as defined in claim 1 wherein a plurality of patterns for sensitivity detection, each of which is constituted of the plurality of the images for sensitivity detection, are formed on the photosensitive material, and
the sensitivity of the photosensitive material is detected with respect to each of the thus formed patterns for sensitivity detection.

8. An exposure correcting method, comprising the steps of:
i) obtaining information representing a sensitivity having been detected with a method of detecting sensitivity of a photosensitive material by use of an exposure apparatus provided with a spatial light modulation device, which has a plurality of pixel sections arrayed in two-dimensional directions and which radiates out an irradiated light beam from each of the pixel sections and in accordance with given image information, the exposure apparatus operating in order to form an image, which corresponds to the given image information and which is constituted of spot images in accordance with radiated light beams having been radiated out respectively from the pixel sections of the spatial light modulation device, on the photosensitive material,
the method of detecting sensitivity of a photosensitive material comprising:
forming a plurality of images for sensitivity detection on the photosensitive material, each of the images for sensitivity detection being constituted of a plurality of the spot images dispersed within a predetermined unit area, the number of the spot images dispersed within the predetermined unit area being set so as to become large in stages among the plurality of the images for sensitivity detection, and
detecting the sensitivity of the photosensitive material in accordance with the plurality of the images for sensitivity detection, which have been formed on the photosensitive material, and
ii) correcting energy of the irradiated light beam, which is irradiated to each of the pixel sections of the spatial light modulation device at the time of an exposure operation performed by the exposure apparatus and with respect to a photosensitive material of the same kind as the photosensitive material having been subjected to the sensitivity detection, in accordance with the sensitivity having been detected with the method of detecting sensitivity of a photosensitive material.

9. An exposure correcting method as defined in claim 8 wherein, in the method of detecting sensitivity of a photosensitive material, the photosensitive material is moved with respect to the spatial light modulation device, the plurality of the images for sensitivity detection being thereby formed on the photosensitive material, and
each of the spot images has a size larger than an array pitch of the spot images, which array pitch is taken in a direction normal to the direction of the movement of the photosensitive material with respect to the spatial light modulation device.

10. An exposure correcting method as defined in claim 9 wherein, in the method of detecting sensitivity of a photosensitive material, each of the spot images has a size at least two times as large as the array pitch of the spot images, which array pitch is taken in the direction normal to the direction of the movement of the photosensitive material with respect to the spatial light modulation device.

11. An exposure correcting method as defined in claim 8 wherein, in the method of detecting sensitivity of a photosensitive material, each of the spot images has a size larger than a width of a minimum element constituting the image information, which minimum element is represented by a predetermined recording resolution.

12. An exposure correcting method as defined in claim 11 wherein, in the method of detecting sensitivity of a photosensitive material, each of the spot images has a size at least two times as large as the width of the minimum element constituting the image information, which minimum element is represented by the predetermined recording resolution.

13. An exposure correcting method as defined in claim 8 wherein, in the method of detecting sensitivity of a photosensitive material, each of the spot images has a size equal to at least a mean value of distances between centers of gravity on adjacent minimum elements constituting the image information, which minimum elements are represented by a predetermined recording resolution.

14. An exposure correcting method as defined in claim 8 wherein, in the method of detecting sensitivity of a photosensitive material, a plurality of patterns for sensitivity detection, each of which is constituted of the plurality of the images for sensitivity detection, are formed on the photosensitive material, and
the sensitivity of the photosensitive material is detected with respect to each of the thus formed patterns for sensitivity detection.

15. A system for detecting sensitivity of a photosensitive material by use of an exposure apparatus provided with a spatial light modulation device, which has a plurality of pixel sections arrayed in two-dimensional directions and which radiates out an irradiated light beam from each of the pixel sections and in accordance with given image information, the exposure apparatus operating in order to form an image, which corresponds to the given image information and which is constituted of spot images in accordance with radiated light beams having been radiated out respectively from the pixel sections of the spatial light modulation device, on the photosensitive material,
the system comprising:
sensitivity detection control means for controlling the spatial light modulation device such that a plurality of images for sensitivity detection are formed on the photosensitive material, each of the images for sensitivity detection being constituted of a plurality of the spot images dispersed within a predetermined unit area, the number of the spot images dispersed within the predetermined unit area being set so as to become large in stages among the plurality of the images for sensitivity detection.

16. A system for detecting sensitivity of a photosensitive material as defined in claim 15 wherein the system further comprises:
an optical system, which is located between the spatial light modulation device and the photosensitive material, the optical system forming the spot images in accordance with the radiated light beams, which have been radiated out respectively from the pixel sections of the spatial light modulation device, on the photosensitive material, and
movement means for moving the photosensitive material with respect to the optical system and the spatial light modulation device,
the optical system being constituted such that each of the spot images has a size larger than an array pitch of the spot images, which array pitch is taken in a direction normal to the direction of the movement of the photosensitive material with respect to the optical system and the spatial light modulation device.

17. A system for detecting sensitivity of a photosensitive material as defined in claim 16 wherein the optical system is constituted such that each of the spot images has a size at least two times as large as the array pitch of the spot images, which array pitch is taken in the direction normal to the direction of the movement of the photosensitive material with respect to the optical system and the spatial light modulation device.

18. A system for detecting sensitivity of a photosensitive material as defined in claim 15 wherein the system further comprises:
an optical system, which is located between the spatial light modulation device and the photosensitive material, the optical system forming the spot images in accordance with the radiated light beams, which have been radiated out respectively from the pixel sections of the spatial light modulation device, on the photosensitive material,
the optical system being constituted such that each of the spot images has a size larger than a width of a minimum element constituting the image information, which minimum element is represented by a predetermined recording resolution.

19. A system for detecting sensitivity of a photosensitive material as defined in claim 18 wherein the optical system is constituted such that each of the spot images has a size at least two times as large as the width of the minimum element constituting the image information, which minimum element is represented by the predetermined recording resolution.

20. A system for detecting sensitivity of a photosensitive material as defined in claim 15 wherein the system further comprises:
an optical system, which is located between the spatial light modulation device and the photosensitive material, the optical system forming the spot images in accordance with the radiated light beams, which have been radiated out respectively from the pixel sections of the spatial light modulation device, on the photosensitive material,
the optical system being constituted such that each of the spot images has a size equal to at least a mean value of distances between centers of gravity on adjacent minimum elements constituting the image information, which minimum elements are represented by a predetermined recording resolution.

21. A system for detecting sensitivity of a photosensitive material as defined in claim 15 wherein the sensitivity detection control means controls the spatial light modulation device such that a plurality of patterns for sensitivity detection, each of which is constituted of the plurality of the images for sensitivity detection, are formed on the photosensitive material.
